(19) United States
(12) Patent Application Publication
(10) Pub. No.: US 2021/0298247 A1
(43) Pub. Date: Sep. 30, 2021

(54) GREENERY EDGE CONTROL METHOD AND EDGING DEVICE

(71) Applicant: LAWN TRIM PTY LTD, Castle Hill, NSW (AU)

(72) Inventor: George DAHER, Castle Hill, NSW (AU)

(21) Appl. No.: 17/266,171

(22) PCT Filed: Aug. 5, 2019
(86) PCT No.: PCT/AU2019/000094

§ 371 Date: Feb. 5, 2021

(30) Foreign Application Priority Data
Aug. 9, 2018 (AU) 2018902913

(51) Int. Cl. A01G 9/28

(52) U.S. Cl. CPC A01G 9/28

(57) ABSTRACT

A horticultural edging device includes at least one cap for location adjacent a green periphery, and a drive mechanism for moving the cap between a first (closed) position and a second (open) position, then returning the cap to the first position wherein at least a portion of the green periphery is covered and growth inhibited.

### FIELD OF INVENTION

The present invention relates to the field of horticulture.

In one form, the invention relates to controlling growth in a garden.

In one particular aspect the present invention is suitable for use for the control of ground cover, particularly grass lawn edges.

It will be convenient to hereinafter describe the invention in relation to domestic lawns of the type associated with yards adjacent a house, however it should be appreciated that the present invention is not limited to that use only and includes lawns on public and private property. Furthermore, while the invention will be described principally with reference to lawns the invention is not so limited and can be used to edge other types of horticultural greenery such as areas of ground covering plants, moss and lichen and the like.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Gardens, verges and nature strips play a major part in the beautification of our modern world. Lawns can be the major component of these private or public spaces. The periphery of a lawn may be defined by a wide range of garden features including a building, garden bed, path, driveway, garden ornament or combination thereof. Alternatively, or in addition, the periphery may be defined by a physical barrier such as a narrow ribbon of metal sheet or rigid plastic held vertically by multiple small stakes pushed in the ground.

Lawn management and beautification usually involves clipping lawn edges. Keeping lawn edges neat and within a desired periphery often requires a great amount of time and effort. Lawn management on public or private property involves a significant proportion of labour time, fuel consumption, equipment purchase and equipment maintenance.

The current methods of lawn edge maintenance are focused around physically clipping or cutting the lawn edge that grows over the desired lawn periphery. Another method of control involves, spraying liquid herbicides along the desired periphery to kill the overgrowth and thereby maintaining the lawn to within a desired periphery.

A particularly preferred and common method of lawn periphery control involves clipping or cutting to create a clean-cut edge. Spraying chemicals is less common because it can cause the edge to be irregular, withered and somewhat unsightly. A range of lawn edge clipping tools and machinery are available, including hand held garden scissors, a rolling scissor guided by the border, line-trimmers which cut blades of grass by using a fast-spinning chord, and elaborate machines that may use cutting blades rotating at high speed.

These edge-clipping tools are labour intensive and costly. Furthermore, the tools are often operated in close proximity to residences, roadways and footpaths exposing the users and bystanders such as pedestrians and vehicles to significant hazards and noise. One particular hazard is the risk posed by flying debris, projectiles and dust around the working area when the high-speed rotating cutting blades come into contact with soil, twigs and pebbles.

Domestic use of powered edge-clipping machinery poses a particularly high risk to users and bystanders, if the user lacks competency, expertise or experience. There are no performance or training prerequisites for operators of this type of machinery. Safety protocols may not always be adhered to, and are difficult to police. This can result in significant injuries to both the user and bystanders due to flying debris and projectiles, or due inadvertent contact with the blades rotating at high-speed.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

### SUMMARY OF INVENTION

An object of the present invention is to provide improved control of greenery.

A further object is to provide improved control of perimeter overgrowth of groundcover such as a lawn.

Another object is to provide a novel edging for ground cover

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

The device of the present invention provides a cap adapted for translational motion to repeatedly cover and inhibit growth at selected edges of a green area. In a first aspect of embodiments described herein there is provided a horticultural edging device comprising:
at least one cap for location adjacent a green periphery, and
a drive mechanism for moving the cap between a first (closed) position and a second (open) position, then returning the cap to the first position wherein at least a portion of the green periphery is covered and growth inhibited.

The drive mechanism may repeatedly move the cap between the first position and second position for ongoing inhibition of green growth at the periphery. In a preferred embodiment, the device of the present invention becomes the new periphery of the green area and inhibits the greenery from crossing the device, thus keeping the periphery well defined. In this manner, maintenance of a desired definition of the green area is made less onerous. The green periphery may be, for example, the periphery of a lawn or the periphery of an area covered by low, ground covering plants, moss, lichen or similar. The device may, for example, be located at the periphery of fescu grass and thus provide edging that divides it from another type of grass such as couch. Thus, the green periphery can include the outer perimeter of an area of greenery. Alternatively or in addition, it can be located within the area of greenery, such as the green periphery around a paving stone or step or around the base of a tree.

In a second aspect of embodiments described herein there is provided a horticultural edging device comprising:
a cap comprising at least one strip, for location adjacent a lawn periphery, and
a drive mechanism for moving the cap between a first position and a second position, then returning the cap to the first position wherein at least a portion of the lawn periphery is covered and growth inhibited.

The cap may define the periphery of the lawn or be attached to an existing lawn edging such as the edge of a brick path or the edge of a concrete driveway. The cap covers, and alters the ecology of the periphery of the lawn to inhibit overgrowth that would otherwise invade areas adjacent the lawn. The cap alters the ecology by changing temperature, airflow, light exposure and other vital factors required for lawn growth. There is therefore a herbicidal effect on lawn covered by the cap. The cap may also impose some pressure on the lawn periphery, pressing it to the ground and better managing the ecology under cover.

In a third aspect of embodiments described herein there is provided a horticultural edging device comprising:
at least one cap for location adjacent a green periphery,
a drive mechanism for moving the cap of the edging device between a first position in which the cap is at least partially covered by overgrowth of the green periphery, and a second position in which the cap is free of the overgrowth,
then returning the cap to the first position such that at least a portion of the overgrowth is covered by the cap and growth inhibited.

The cap commences in a first position, moves to a second position in which it can better cover blades of grass overgrowing the periphery of the lawn. It then typically returns to the first position. The movement from the first position to the second position, then back to the first position constitutes one movement cycle. Choosing an appropriate frequency of movement cycles is important to efficacy of the device and will vary with a number of factors. The cap may be stationary at the first position, and then move to a second position by moving upwards such as by a pivoting, lifting or sliding motion. In the second position, the strip is thus ‘open’, facing the encroaching lawn overgrowth that is moving outward from the main body of lawn. Finally, the cap pivot downwards, closing and returning to the first position such that the overgrowth is trapped and covered.

The cap may be of any convenient conformation, shape or size. For example, when the greenery is a square lawn having a periphery comprising four straight lines, it may be convenient to use caps configured as four or more straight strips, or four straight strips and four curved corner strips. Alternatively, when the green periphery is within the lawn area or defined by irregularly shaped features such as pavers or steps, it may be convenient to use caps of different shapes.

In a particularly preferred embodiment the cap is in the form of an elongate strip. The strip, or combination of strips may be of any convenient length, width or thickness and these parameters may vary in the horizontal or longitudinal directions. For example the strip may be straight, curved or including straight and curved portions to follow the shape of a periphery.

The cap may be substantially two-dimensional, that is, fitting to a flat surface. Alternatively, the cap may be three-dimensional in order to fit a non-flat surface such as an upward spiralling pathway in order to accurately form the desired border. Optimally, when the cap is in the first position it follows the periphery of the lawn and is as near as practical to being flush with the ground from which the lawn is growing or at least does not pose a mobility hazard or trip hazard.

In a particularly preferred embodiment, the cap in the first position presses the overgrowing grass. The cap will remain in the first position most of the time. A biasing means may be used to press the cap onto the grass. The cap may also be at a slight angle in order to impart some pressure on the overgrowing grass.

The cap may vary in thickness to achieve desirable structural integrity for an application. For example, part or the whole of the cap may need to be very thick if cars are to be driven over it. Portion(s) of the cap may need to be thick where cars drive over it and one or more portions may need to be thinner where pedestrians walk over it.

The cap may be thinner and have less structural demands if it is mounted to, and supported by a substantial structure such as the edge of a concrete footpath. Typically, the cap will need to be more robust if it is self-supporting and forming edging between a lawn and a garden bed, or if it is to be used for stepping on.

In another aspect of embodiments described herein there is provided a method of edging greenery using the horticultural edging device of the present invention, the method comprising the steps of:
locating the edging device adjacent a green periphery,
activating the drive mechanism to move the at least one cap of the edging device between a first position and a second position, then returning the cap to the first position wherein at least a portion of the green periphery is covered and growth inhibited.

Preferably, the green periphery is the periphery of a lawn or an area populated by one or more ground cover plants.

The translational motion imposed by the motor may include pivoting, lifting, lowering, sliding or oscillatory movement or combinations thereof. The cap will remain in the first position other than the period of the cycle when it is undergoing translational motion. The movements may include any convenient combinations, sequences and successions. For clarity, the motion does not include geographical movement, such as lateral movement from one part of the garden to another. The motion or combination of motions are intended to cause the cap to cover and terminate the lawn overgrowth that would otherwise encroach on areas outside the periphery of the lawn.

Typically, a motor powered by mains electricity, battery or solar power, or combinations thereof activates the drive mechanism. Alternatively, the drive mechanism may be activated manually, or the motor may have a manual override.

Typically, the drive mechanism is controlled by a timer that is powered by mains electricity, battery or solar power, or combinations thereof. Alternatively, the timer may be activated manually, or may have a manual override. The timer may be directly or remotely programmed to the desired frequency, timing and duration of the cap cycling from the first position, to the second position and then back to the first position.

In yet a further aspect of embodiments described herein there is provided a method of controlling a green periphery, the method comprising the steps of:
locating the edging device adjacent a green periphery,
activating the drive mechanism,
moving the at least one cap of the edging device between a first position in which the cap is at least partially covered by overgrowth of the green periphery, and a second position in which the cap is free of the overgrowth,
then returning the cap to the first position such that at least a portion of the overgrowth is covered by the cap and growth inhibited.

Other aspects and preferred forms are disclosed in the specification and/or defined in the appended claims, forming a part of the description of the invention.

In essence, embodiments of the present invention stem from the realization that by controlling the physical environment at the edges of a ground cover greenery such as a lawn, unwanted overgrowth of the ground cover greenery can be inhibited. Specifically, depriving the ground cover of light will halt its encroachment on other types of greenery, or other areas, or structures.

Advantages provided by the present invention comprise the following:
avoids the hazards to people and plants that are associated with chemical herbicides,
avoids the dangers associated with using mechanised edging machines,
can facilitate the use of mowers or other cutting devices on the main body of greenery,
reduces the amount of labour required to maintain an area of greenery,
can provide an aesthetic garden border, divider or other garden feature,
can have a secondary function, such as a paver or step or other feature,
can be incorporated with, or installed in conjunction with auxiliary systems such as lighting, sound or surveillance systems to improve safety, amenability and aesthetics of a garden.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates in schematic cross section one embodiment of the device of the present invention which includes a cap in the form of a strip that may be rotated about a hinged edge;

FIG. 2 illustrates in schematic cross section an embodiment of the device of the present invention wherein the cap may be vertically raised and lowered;

FIG. 3 illustrates a device of the present invention located at the periphery of a lawn bordered by two brick walls that meet to form a corner;

FIG. 4 illustrates in schematic cross section a device according to the present invention and auxiliary devices installed at the edge of a footpath;

FIG. 5 illustrates in schematic cross section the capture range of a device according to the present invention;

FIG. 6 illustrates in schematic cross section the sequence of operation of a device according to the present invention; and

FIG. 7 again illustrates in schematic plan view two embodiments of the present invention.

### DETAILED DESCRIPTION

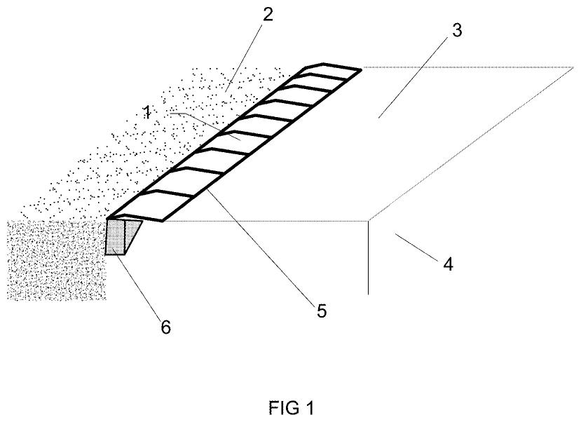

For purposes of description herein, the terms “upper,” “lower,” “right,” “left,” “rear,” “front,” “vertical,” “horizontal,” “interior,” “exterior,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

The device and method of the present invention does not interfere with the general growth of an expanse of lawn. The present invention is specifically directed to the over-growth along the periphery of a lawn, comprising the horizontal growth that invades areas adjacent the lawn. This is the overgrowth that the prior art addresses by clipping or chemical means to stop the lawn from outgrowing its space and overtaking surrounding spaces such as footpaths or gardens.

The green edging device of the present invention comprises at least one cap for location adjacent a green periphery and a drive mechanism for controlling translational movements, such as pivoting or levering of the cap, between a first position and a second position to cover the overgrowth at the green periphery.

The cap will have any a suitable width, thickness, length and configuration for the intended purpose. Typically, the cap is made of a material having the flexibility, opacity, durability, weather resistance and surface finish required for the application. The cap may also be designed in accord aesthetic considerations, such as having a colour, pattern or texture that matches or contrasts surrounding footpaths, ornaments or building colours.

The drive mechanism may configured according to the type of movement required for the desired application. For example, the drive mechanism may include hinges, pistons, screws, hydraulic components, pneumatic components or magnetic components. The drive mechanism may be actuated by a motor, or a wound clock-work mechanism, or manually, or may include a motor having a manual override.

Typically, any motor used to actuate the drive mechanism is located adjacent the cap, either above ground or buried. The motor may be associated with any convenient source of power including mechanical, electric, battery or solar power or combinations thereof. The device of the present invention may also be manually operated, or include a manual override. For example, a user may have a proprietary tool by which they can operate the drive mechanism.

FIG. 1 depicts in cross section an embodiment of the device of the present invention. FIG. 1 depicts the cap of the device in the form of a strip (1) in the first position, installed adjacent a concrete footpath (2) and lawn (3) covering soil (4). The strip (1) follows the desired lawn periphery (5) and the desired lawn height. The strip (1) is hinged and a drive mechanism (6) moves the strip (1) between the first position and a second position, then returning the strip (1) to the first position.

The strip may also undergo other translational movements to entrap the lawn growth. These include lifting and sliding movements. The strip may be lifted, slid, or otherwise moved from a first position to a prescribed height (secondary position) subsequently return to the first position.

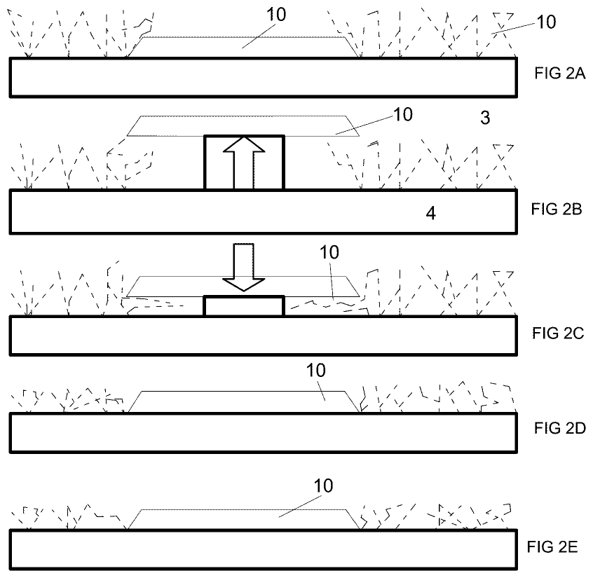

FIG. 2 depicts a further embodiment of the device of the present invention. While the cap in the form of a strip depicted in FIG. 1 is hinged along one edge, the cap depicted in FIG. 2 is raised and lowered. This embodiment is particularly useful for location between pavers. Alternatively, the cap may have a second function as a paver of any convenient shape. Multiple caps may be used to provide steps of a pathway.

FIG. 2A depicts the cap (10) in the fully lowered first position and surrounded by lawn (3) that is starting to overgrow the periphery about the cap. FIG. 2B depicts the cap in the second position, lifted vertically by the drive mechanism (not shown) in the direction of the arrow so that the cap (10) is slightly higher than the blades of grass. FIG. 2C depicts the cap (10) as it returns towards the first position, catching the overgrowing blades of grass and pressing them towards the soil (4). FIG. 2D depicts the cap (10) once it has returned to the first position with the overgrowth firmly packed beneath the cap (10). The cap (10) has a flat upper surface that is in horizontal alignment with the height of the lawn. FIG. 2E depicts the cap (10) with lawn overgrowth decomposing underneath due to pressure and lack of light.

The device may include a function that slightly raises or lowers the cap when the lawn is mowed. Slightly lowering the cap beneath the height of the lawn would facilitate an improved cut at the edges of the cap. Alternatively, lifting the cap slightly may lift lawn overgrowth slightly into the blades of the mower, again improving the mower finish around the cap.

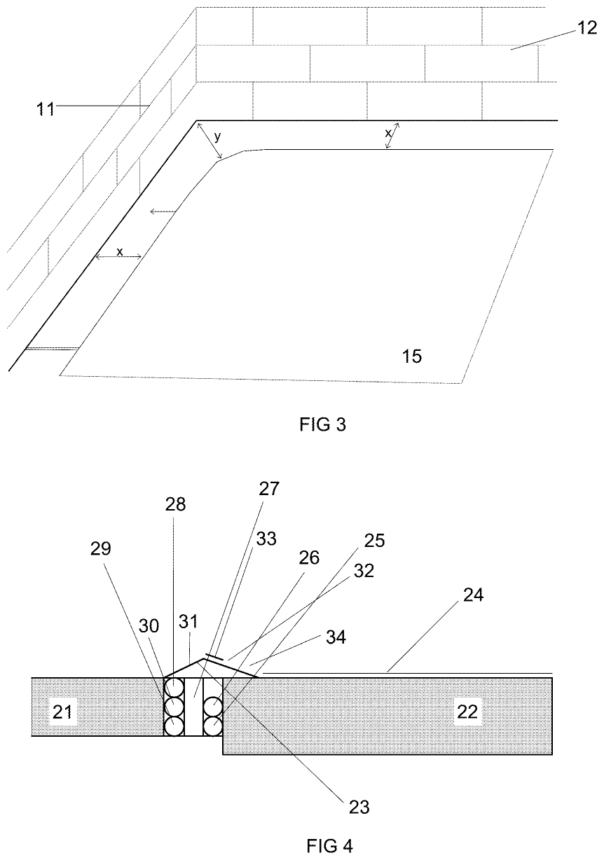

The cap may vary in shape and width to cover parts of the lawn periphery that are not readily accessible with a lawn mower. FIG. 3 depicts the periphery of a lawn (15) within two brick walls (11, 12) which form a corner that restricts lawn mower access. In this embodiment of the device, the corner cap (13) is configured with a curved internal edge, allowing the lawn mower to cover all of the lawn. The width of the cap increases into the corner (distance y is greater than distance x) and the cap thus covers the unreachable space in the lawn.

If the device is manually operated then the operator may use a proprietary tool to drive the apparatus, which facilitates the required movements of the cap.

The device of the present invention may additionally include a timer to regulate the operations of the device, actuating the drive mechanism to move the cap between the first position and the second position and optionally, subsequent positions. The repetition of the movement cycle (frequency) is intended to repeatedly cover and restrict any new lawn growth at the periphery of the lawn. The frequency, timing and duration of the cycle is typically under the direct or remote control of the operator and can be pre-set. Optimally the user will have the option of following suggested settings from a program (such as an app) or a manual.

The timer may be actuated by the motor, or a wound clock-work mechanism, or manually, or may include a manual override.

As mentioned above the cycle comprises movement of the cap from the first position to the second positon and then return to the first position. Optionally, the movement cycle has a duration of less than a minute. Setting an appropriate cycle frequency is important for efficacy of the device.

Preferably, the timer is programmable so that the timing, frequency and duration of operation can be varied with the seasons, type of greenery, average temperatures, rainfall, available nutrients, local climate or other relevant parameters. For example, if the greenery comprises a short leafed slow growing grass in a cool temperate or dry terrain, the cap may only need to move once a week, whereas a long leafed, vigorous growing grass in a warm temperate climate might require the cap to be moved daily. The frequency is preferably optimised so that the growth of the peripheral greenery does not overgrow the cap and its capture area and compromise its operation.

The timer may be associated with any convenient source of power including mechanical, electric, battery or solar power or combinations thereof. The timer may also be manually operated, or include a manual override. For example, a user may have a proprietary tool by which they can operate the drive mechanism.

The device of the present invention may be mounted to an existing garden feature adjacent the periphery of the lawn such as a concrete footpath edge and will be required to accurately follow that edge. In another embodiment of the present invention, the device of the present invention may be used to edge one variety of ground cover, dividing it from another type of ground cover such as two different varieties of lawns, or a lawn and a moss cover. In another embodiment of the present invention the device is used to edge ground covers at different heights, such as areas of lawn of different heights, for aesthetic or artistic purposes. Thus, the device of the present invention may be located at the periphery of different types of greenery to create many and varied divisions, not just an outer perimeter.

In applications where there is an absence of an existing garden structure or other tangible divider between the lawn and another area of the garden the device will perform the function of edging the periphery of the lawn. Clearly the structural integrity of the device must be appropriate for the application. For example, the device may also perform the function of a soil retainer, being the support for the soil and other loads applied near the periphery. Alternatively, if the cap is to be used as a paver or step in a path, it must be sufficiently robust to withstand bodyweight and repeated footfalls.

The device of the present invention must also be installed appropriately, for example, it may need to fit neatly, so as to avoid formation of projecting edges or steps to avoid forming stumbling hazards or other mobility hazards to pedestrians or cyclists or others who might traverse the device or come into close proximity.

Preferably, the timing of the movement of the strip between the first position and the second position avoids causing any mobility hazards. For example, the timer may trigger the cycle at 3:00 am when it would be unlikely that people would be walking over the device. Speeding up the movement cycle may also reduce the mobility hazard, by reducing the time that the strip is lifted and thus constitutes a hazard. The movement cycle for example can take only a few seconds at an appropriate time. The movement cycle may also only need to be triggered once every few days.

Other safety features may include warning devices such as flashing lights adjacent the device to warn those nearby of the movement of the strip. Such measures may be taken for example, in public gardens where it is more likely that people are about at all times of the day or night. There is less of a need for warning devices in a suburban back-yard where it would be unlikely that there are people walking over or near the device at 3:00 am.

The device may also include other lighting features that are particularly helpful in low light situations or bad weather, such as lights that are manually turned on or automatically activated by sensors at night for safety or security. Lighting may also be useful for delineating the edge of a footpath, road or driveway. Alternatively, or in addition, lighting may simply be used to beautify the garden of footpath.

It will be readily apparent to the person skilled in the art that the device may be associated with other useful garden features such as a sound system, public address system, surveillance cameras or microphones.

FIG. 4 depicts a further embodiment of the device of the present invention installed at the edge of a cement footpath (21) adjacent the periphery of a lawn (24) on soil (22). The drive mechanism is provided as a module (27). The device includes a water pipe (29) for a watering system and a nozzle (32) for spraying water onto the lawn (22). An electrical conduit (26) carries electrical cable to supply power to the device and a conduit (28) is provided for hydraulic or pneumatic systems if they are required to drive movement of the cap. A conduit (25) is also provided for a data cable to microphones, cameras, speakers and the like. A spare conduit (30) is provided for any other needs. Fittings (31) are provided for use with the lighting, speakers or cameras. Solar panels (33) collect energy for battery storage.

Periodic inspection and maintenance would assist in keeping the device in proper position and alignment, so that it operates efficiently and does not become a tripping hazard or mobility hazard. The device may have a manual or automatic maintenance function that allows it to be opened for adjustment or cleaning, particularly to remove green debris or soil, and then returned to the first position.

In a preferred embodiment the device includes a cleaning apparatus that automatically brushes, sweeps or washes decomposed greenery out from under the cap when it is in the second (open) position.

Preferably, the device operates with a frequency that avoids greenery overgrowing the cap while it is in the first (closed) position and stop it operating properly. In other words, the greenery at its periphery has grown past the capture range of the cap. The capture range for the cap will vary with factors such as the dimensions of the cap and the variety of greenery.

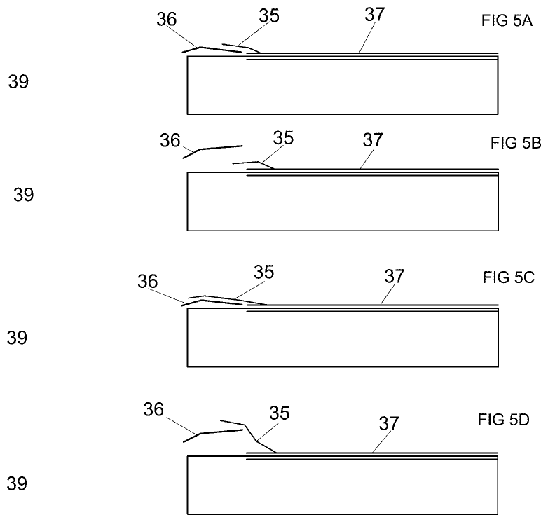

FIG. 5 illustrates the concept of a capture range with reference to the edging device of the present invention when located at the periphery of a lawn (37) and adjacent a concrete path (39).

As depicted in FIG. 5A, within the capture range of the device, the lawn overgrowth (35) has only partially overgrown the cap (36) and the cap can freely move from the first position, to the second position and return to the first position, capturing the overgrowth under the cap (36) (FIG. 5B). As depicted in FIG. 5C, when the overgrowth has exceeded the capture range of the device, the cap is so overgrown that it either cannot move, or cannot move sufficiently to capture the overgrowth under the cap (FIG. 5D).

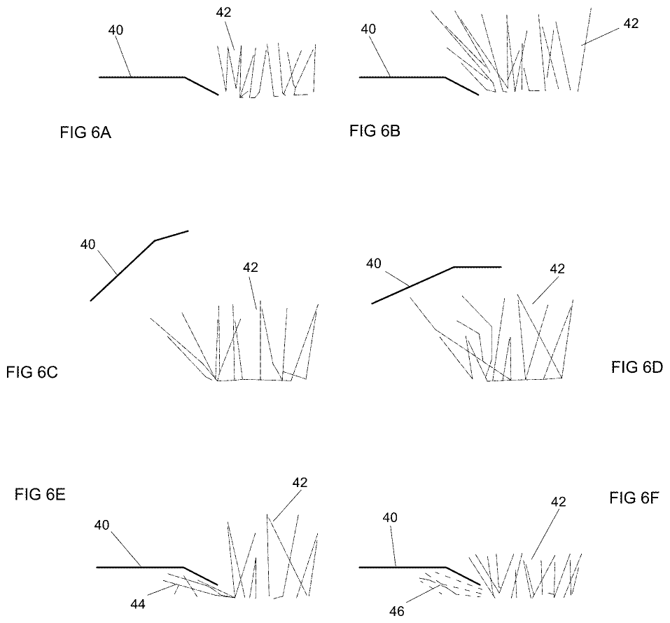

FIG. 6 illustrates in cross section the sequence of operation of a device according to the present invention. FIG. 6A shows the cap (40) in the first (closed) position with blades of grass (42) comprising a lawn adjacent an edge. The cap remains in this position until a timer initiates the movement cycle. FIG. 6B shows the blades of grass (42) beginning to encroach upon the cap. The blades of grass would typically grow taller and depending on the type of lawn, runners may also grow towards the edging device and invade the area adjacent the cap. In this manner, the desired perimeter of the law would start to be lost.

FIG. 6C illustrates the cap lifting according to a pre-determined movement cycle to the second (open) position. In the second position the cap is sufficiently raised to capture the lawn overgrowth invading the edging. FIG. 6D illustrates the cap lowering and returning to the first position. The cap thus clutches and encapsulates part of the overgrowing lawn (44) that was invading the edging.

FIG. 6E illustrates the cap continuing its return to the first position. The lawn overgrowth (44) is covered by the cap. The ecological factors favouring lawn growth are diminished under the cap, leading to withering and eventual termination of the encapsulated overgrowth. FIG. 6F illustrates the encapsulated lawn under the cap decomposing (46) into the soil. Alternatively, the dead remnants of the overgrowth may be cleaned out according to a maintenance programme. Optimally, only regular lawn mowing would be required and the lawn would not exceed the desired perimeter defined by the edging device of the present invention.

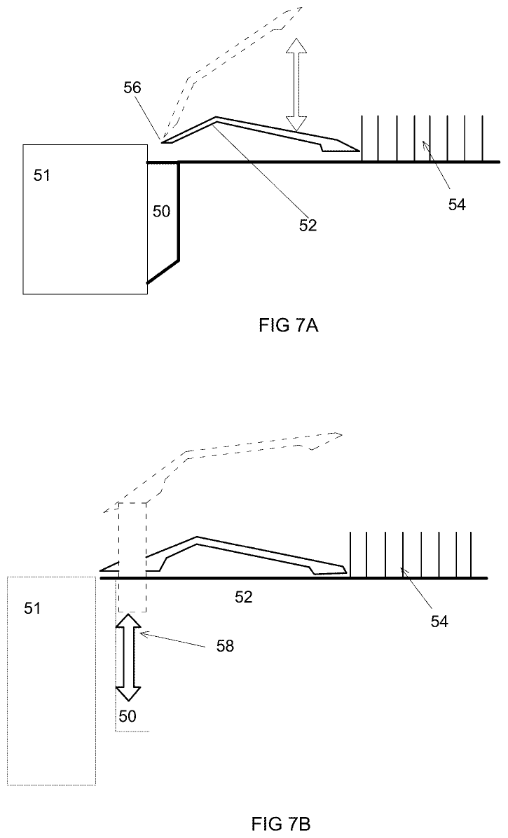

FIG. 7 again illustrates in plan view two embodiments of the present invention. FIG. 7A illustrates a hinged cap version of the edging device showing a fixed structure (51) such as a concrete footpath defining the desired lawn perimeter. The cap (52) is shown in the first position, flush with the ground level and the arrow indicates the preferred height to which the cap (52, shown by broken lines) may rise above the lawn (54). The cap (52) pivots about a powered hinge (56) associated with the body (50) of the edging device located adjacent the desired lawn perimeter.

FIG. 7B is substantially the same as FIG. 7A but the cap (52) is powered to move vertically up and down in the direction of the arrow from the first position to the second position by virtue of a mechanism (58) that works on a mechanical, hydraulic, pneumatic or magnetic basis.

The method of the present invention could for example, include the following steps:
a. The edging device of the present invention is located at a green area, such as the edge of a lawn, customised to fit the desired peripheral shape;
b. A timer associated with the edging device is programmed to trigger desired frequency, duration and timing of operation;
c. The timer triggers the drive mechanism to initiate movement of the cap;
d. The cap takes a few seconds to move from the first position to the second position;
e. The cap takes a few more seconds to return to the first position, encapsulating, covering and pressing on any new lawn growth that was overtaking the cap;
f. The covering cap remains in the first position, depriving the newly covered lawn overgrowth of light, and possibly moisture or other ecological factors required for survival;
g. The cap remains in the first position until at a pre-programmed date and time, when the timer again triggers the drive mechanism to initiate movement of the cap and steps c to f are repeated, thus continually addressing growth at the edge of the lawn.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. (canceled)

2. (canceled)

3. (canceled)

4. (canceled)

5. (canceled)

6. (canceled)

7. A horticultural edging device for controlling overgrowth from an edge of horticultural greenery, the overgrowth extending beyond the edge of the greenery, the horticultural edging device comprising at least one cap positioned adjacent the edge of the greenery when installed, the cap operable for movement in a cyclical mode which includes movement of the cap from a first position in which at least some of the overgrowth in the region of the cap can overlie the cap, to a second position in which at least some of the overlying growth can enter a capture area below the cap, and thereafter return to the first position in which the overgrowth below the cap is entrapped under the cap.

8. The device according to claim 7, further comprising a drive mechanism for causing movement of the cap between the first and second positions.

9. The horticultural device according to claim 7, wherein the cap is mounted for pivotal movement between the first and second positions.

10. The horticultural device according to claim 7, wherein the cap is mounted for movement in a substantially vertical direction between the first and second positions.

11. The horticultural device according to claim 7, further comprising a body said cap being operatively mounted to said body.

12. The horticultural device according to claim 8, comprising a timer associated with the drive mechanism and arranged to cause selective operation thereof.

13. The horticultural device according to claim 7, wherein the cap comprises a strip having opposed spaced apart edges.

14. The horticultural device according to claim 7, comprising biasing means for urging the cap into the first position.

15. The horticultural device according to claim 8, wherein the drive mechanism is manually operable.

16. The horticultural device according to claim 8, wherein the drive mechanism is powered.

17. The horticultural device according to claim 7, wherein the cap is mounted for a combination of pivotal and substantially vertical movement between the first and second positions.

18. A method for controlling overgrowth from an edge of horticultural greenery, the overgrowth extending beyond the edge of the greenery, the method including the steps of: locating horticultural edging device in accordance with claim 7 adjacent the edge of the horticultural greenery and moving the at least one cap from the first position to the second position and thereafter returning the at least one cap from the second position to the first position.

19. The method according to claim 18, wherein the device further includes a drive mechanism for causing the movement between the first and second positions, the method including step of and activating the drive mechanism to cause the movement.
